(19) United States
(12) Patent Application Publication
(10) Pub. No.: US 2006/0022789 A1
(43) Pub. Date: Feb. 2, 2006

(54) Charge dissipative electrical interconnect

(76) Inventors: John R. Kolasinski, Greenbelt, MD (US); Edward J. Wollack, Clarksville, MD (US)

Correspondence Address: NASA GODDARD SPACE FLIGHT CENTER, 8800 GREENBELT ROAD, MAIL CODE 140.1, GREENBELT, MD, 20771, US

(21) Appl. No.: 11/136,766

(22) Filed: May 23, 2005

Related U.S. Application Data
(60) Provisional application No. 60/575,720, filed on May 26, 2004.

(51) Int. Cl. H01H 61/00

(52) U.S. Cl. 337/14

(57) ABSTRACT

A charge-dissipative electrical interconnect comprises at least one first conductive element, a first lossy dielectric layer surrounding the at least one first conductive element, a first shielding element surrounding the first lossy dielectric layer, at least one grounding conductive element electrically contacting the first shielding element, and a second lossy dielectric layer surrounding the first shielding element.

### CROSS REFERENCE TO RELATED APPLICATIONS

This application claims the benefit of priority under 35 U.S.C. 119(e) of U.S. Provisional Patent Application No. 60/575,720 filed May 26, 2004, entitled “Charge Dissipative Electrical Cable,” which is incorporated by reference herein in its entirety.

### ORIGIN OF THE INVENTION

The invention described herein was made by employees of the United States Government and may be manufactured and used by or for the Government of the United States of America for governmental purposes without the payment of any royalties thereon or therefor.

### BACKGROUND OF THE INVENTION

1. Field of the Invention

The present invention relates to an electrical interconnect and, more particularly, to an electrical interconnect configured to dissipate electrical charge and thereby minimize charge build-up on the surface of the interconnect and/or within the interconnect.

2. Description of the Related Art

Electronic systems operating in certain environments, including radiation environments and trapped-ion environments, for example, are prone to the accumulation of electrical charge in various parts of the system. In one example, electrical charge may accumulate in the insulating (e.g., dielectric) materials of cable assemblies used to interconnect system components. Excessive charge accumulation within a cable assembly may disrupt and/or damage the components if charge voltages exceed the dielectric breakdown voltage of the cable assembly and produce an arc-over discharge. Even if a discharge does not occur, elevated charge build-up voltage levels may weaken or gradually degrade the system components.

Several conventional approaches have been used to address the problem of charge build-up in electronic systems. In one approach, cable insulating materials have been impregnated with conductive particles to control the build-up of charge within the insulation. These materials, however, experience micro-arcs between the conductive particles in the material to dissipate the charge. The micro-arcs create electrical noise that may interfere with the signals being carried by the wires of the cable. Further, impregnating the insulating materials may result in non-uniformities within the materials that affect their electrical performance, leading to lower system reliability.

In another conventional approach, grounded metallic housings (e.g., rigid shields) are placed over cable assemblies to minimize charge build-up and the associated arc-over discharges. To provide a requisite degree of protection to the cable assemblies, the housings must be relatively thick, massive, and inflexible. These attributes make metallic housings unsuitable for many applications, including space flight applications.

In a further conventional approach, a conductive layer has been coated on dielectric, cable insulating materials to minimize charge build-up. Being somewhat thin, these coatings are not mechanically robust and may be compromised when the cable assemblies are flexed or if abrasion occurs. Further, these coatings completely fail to address the build-up of charge within the dielectric.

Finally, semiconductive polymers have been used to reduce the build-up of charge in electronic systems. However, these materials are prohibitively expensive for many applications, as well as having low flexibility and low abrasion resistance providing cable assemblies with corresponding low reliability.

### SUMMARY OF EXEMPLARY ASPECTS

In the following description, certain aspects and embodiments of the present invention will become evident. It should be understood that the invention, in its broadest sense, could be practiced without having one or more features of these aspects and embodiments. It should also be understood that these aspects and embodiments are merely exemplary.

To overcome the drawbacks of the prior art and in accordance with the purpose of the invention, as embodied and broadly described herein, one aspect of the invention provides a charge-dissipative electrical interconnect comprising at least one first conductive element, a first lossy dielectric layer surrounding the at least one first conductive element, a first shielding element surrounding the first lossy dielectric layer, at least one grounding conductive element electrically contacting the first shielding element, and a second lossy dielectric layer surrounding the first shielding element.

As used herein, “conductive” means electrically conductive. Electrically conductive materials may, of course, exhibit other forms of conduction (e.g., thermal, etc.) as well.

Further, as used herein, “surrounding” means substantially enclosing and electrically contacting. Also, as used herein, “lossy dielectric” means an undoped insulator having a finite volume resistivity ranging from approximately 1×10⁸ Ω-m to approximately 1×10¹¹ Ω-m.

In another aspect, the invention provides a charge-dissipative electrical interconnect comprising a plurality of first conductive elements, a first lossy dielectric layer surrounding the first conductive elements, a first shielding element surrounding the first lossy dielectric layer, a second lossy dielectric layer surrounding the first shielding element, and at least one grounding conductive element in electrical contact with the first shielding element and at least one of the first lossy dielectric layer and the second lossy dielectric layer.

In a further aspect of the invention, the at least one grounding conductive element may be configured to transfer charge from at least one of the first lossy dielectric layer, the second lossy dielectric layer, and the shielding element, to a zero volt reference element (e.g., electrical ground).

Aside from the structural and procedural arrangements set forth above, the invention could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this specification, illustrate several exemplary embodiments of the invention and together with the description, serve to explain the principles of the invention. In the drawings,

FIG. 1 is a cross-sectional view of a first embodiment of an interconnect according to the present invention;

FIG. 2 is a cross-sectional view of another embodiment of an interconnect according to the present invention;

FIG. 3 is a cross-sectional view of another embodiment of an interconnect according to the present invention;

FIG. 4 is a cross-sectional view of another embodiment of an interconnect according to the present invention;

FIG. 5 is a cross-sectional view of another embodiment of an interconnect according to the present invention; and

FIG. 6 is a cross-sectional view of another embodiment of an interconnect according to the present invention.

### DETAILED DESCRIPTION OF EXEMPLARY EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

The invention provides an electrical interconnect that minimizes the electrical charge build-up on the surface of the interconnect dielectric, as well as internal dielectric charging within the interconnect dielectric. Examples of interconnects according to the invention include cable assemblies (standard round, wire cable assemblies, as well as ribbon cables), electrical connectors, and circuit boards. Circuit board applications include standard rigid circuit boards, as well as flex circuits. Other interconnect applications may also be used.

The charge-dissipative electrical interconnect according to the invention may be effective where electrical charge build-up in electronic systems is induced by external environments. These environments may include trapped-ion environments and ionizing radiation environments, as well as environments where surface charging is common. Trapped-ion and ionizing radiation environments occur in space and in a range of nuclear operations, among others. Surface charging environments are commonly encountered in devices having flexing and rubbing parts, such as inkjet printers, for example, as well as during testing and integration of most electrical systems.

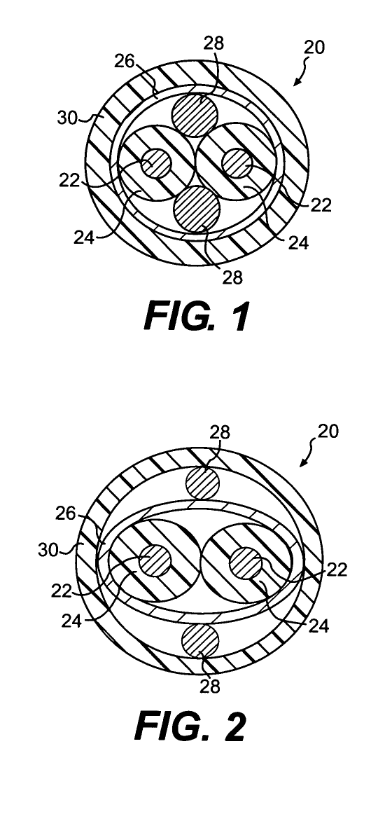

An embodiment of an interconnect 20 according to the present invention is shown in FIG. 1. In the illustrated embodiment, the interconnect 20 comprises a cable that is part of an electrical system, for example. The cable has first conductive elements 22, a first lossy dielectric layer 24 surrounding the first conductive elements 22, a first shielding element 26 surrounding the first lossy dielectric layer 24, two grounding conductive elements 28 electrically contacting the first shielding element 26, and a second lossy dielectric layer 30 surrounding the first shielding element 26.

In one embodiment, the first conductive elements 22 comprise electrical signal-carrying wires. Silver-plated copper wires have been used, but other conductive materials may also be used.

As shown in FIG. 1, each conductive element 22 is surrounded by a discrete first lossy dielectric layer 24. The discrete first lossy dielectric layers 24 may be configured as jackets on the respective wires. The thicknesses of the first lossy dielectric layer 24 and the second lossy dielectric layer 30 may be determined based on the required electrical performance of the system, as well as mechanical packaging constraints, such as abrasion resistance and flexibility.

A lossy dielectric is utilized in the interconnect of the present invention due to its favorable charge mobility features. Lossy dielectrics have a relatively high charge mobility, so that charge can be removed from these materials at a desirable rate.

The charge mobility of a dielectric material is inversely proportional to its volume resistivity. In one embodiment, the lossy dielectric has a resistivity ranging from approximately 1×10⁸ Ω-m to approximately 1×10¹¹ Ω-m. In a further embodiment, the lossy dielectric has a resistivity ranging from approximately 1×10⁹ Ω-m to approximately 1×10¹⁰ Ω-m.

In yet a further embodiment, the lossy dielectric has a resistivity of approximately 1×10⁹ Ω-m m. By contrast, a better insulating dielectric has a volume resistivity of approximately 1×10¹⁶ Ω-m. The better insulating dielectric has an unacceptably low charge mobility, leading to charge buildup in the dielectric.

In one embodiment of the invention, the lossy dielectric comprises a thermoplastic polyester elastomer comprising a crystalline hard segment and an amorphous soft segment. In a further embodiment, the thermoplastic polyester elastomer comprises butylene/poly(alkylene ether) phthalate. HYTREL 7246™ made by DuPont has been used as a lossy dielectric. Other materials exhibiting similar properties may also be used.

In the embodiment shown in FIG. 1, the grounding conductive elements 28 are disposed between the first lossy dielectric layer 24 and the first shielding element 26. Silver-plated copper wires have been used as grounding conductive elements, but other conductive materials may also be used.

The grounding conductive elements 28 are configured to transfer charge to a zero volt electrical reference element (not shown), such as, for example, the system ground. Accordingly, in one embodiment, the grounding conductive elements 28 have a lower impedance relative to the reference element than the first conductive elements 22. In another embodiment, the grounding conductive elements 28 have an impedance of less than about 10 Ω and the first conductive elements 22 have an impedance of greater than about 50 Ω relative to the reference element. In yet another embodiment, the grounding conductive elements 28 have an impedance of approximately 1 Ω and the first conductive elements 22 have an impedance of approximately 75 Ω relative to the reference element.

In the embodiment shown in FIG. 2, the grounding conductive elements 28 are disposed radially outside of the first shielding element 26. Thus, the first shielding element 26 is disposed between the first lossy dielectric layer 24 and the grounding conductive elements 28.

In various embodiments of the invention, the grounding conductive elements 28 may be in electrical contact with the first lossy dielectric layer 24, as shown in FIG. 1, or the second lossy dielectric layer 30, as shown in FIG. 2.

The first shielding layer 26 surrounds the first lossy dielectric layer 24 and electrically contacts the grounding conductive elements 28. In one embodiment, the first shielding element 26 and the grounding conductive elements 28 are in electrical contact along substantially their entire length, e.g., along the entire length of the interconnect. In another embodiment, the first shielding element 26 and the grounding conductive elements 28 are in electrical contact only at end portions of the interconnect. Optionally, the first shielding element 26 is also electrically connected to the system ground.

In one embodiment, the first shielding element 26 comprises at least one of a metal foil and a metal wire braid. Silver-plated copper has been used for the shielding element, but other materials may also be used.

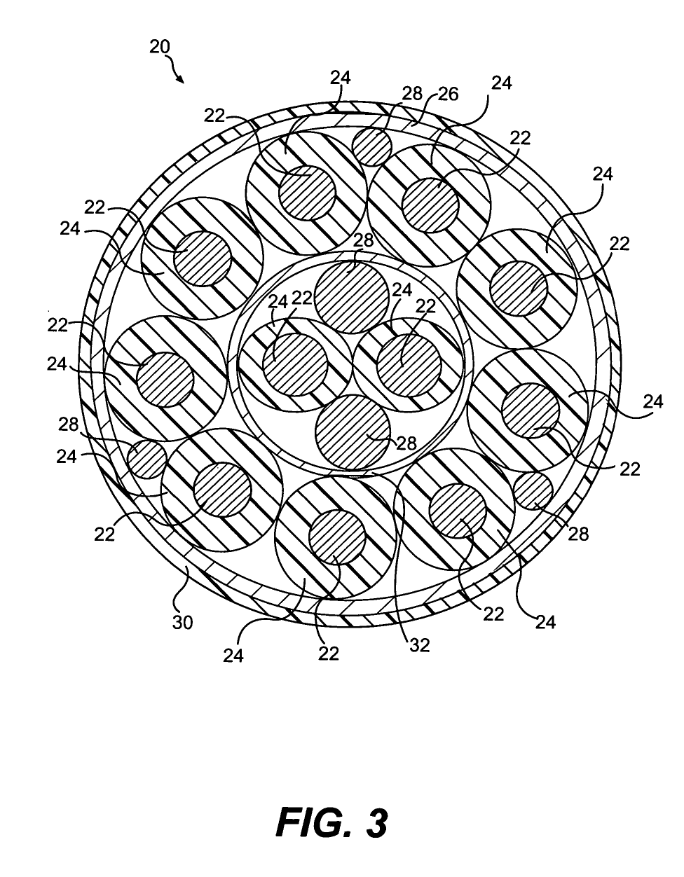

As described above, the charge-dissipative electrical interconnect of the present invention utilizes particular arrangements of a lossy dielectric material and conductors to minimize charge build-up in the interconnect. In some embodiments, the grounding conductive elements are configured to transfer charge from at least one of the first lossy dielectric layer, the second lossy dielectric layer, and the shielding element, to a zero volt reference element, such as the system ground, for example. In the embodiments shown in FIGS. 1 and 3, each first lossy dielectric layer 24 is in electrical contact with at least one of a grounding conductive element 28 and a first lossy dielectric layer 24 that is in electrical contact with a grounding conductive element 28.

In some embodiments, the first conductive elements and the grounding conductive elements are arranged in a cable to form a substantially circular array in cross-section.

The interconnect embodiment shown in FIG. 3 further comprises a second shielding element 32 within the first shielding element 26. As shown, the second shielding element 32 surrounds at least one first conductive element 22 and at least one grounding conductive element 28.

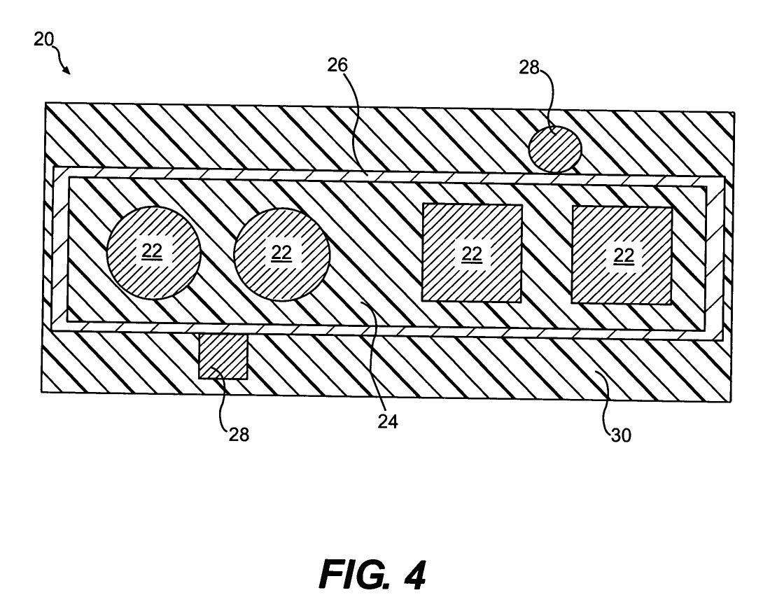

In another embodiment, shown in FIG. 4, the interconnect 20 of the present invention is configured as a flat interconnect. This flat interconnect may comprise a ribbon cable, for example. As shown, the first conductive elements 22 are surrounded by a common first lossy dielectric layer 24. In some embodiments, the common first lossy dielectric layer 24 comprises a substantially continuous coating on the first conductive elements 22. In the substantially continuous coating, there are substantially no gaps between the dielectric layer and the first conductive elements. In this embodiment, as well as in other embodiments, rectangular conductors may be used interchangeably with round conductors, as desired.

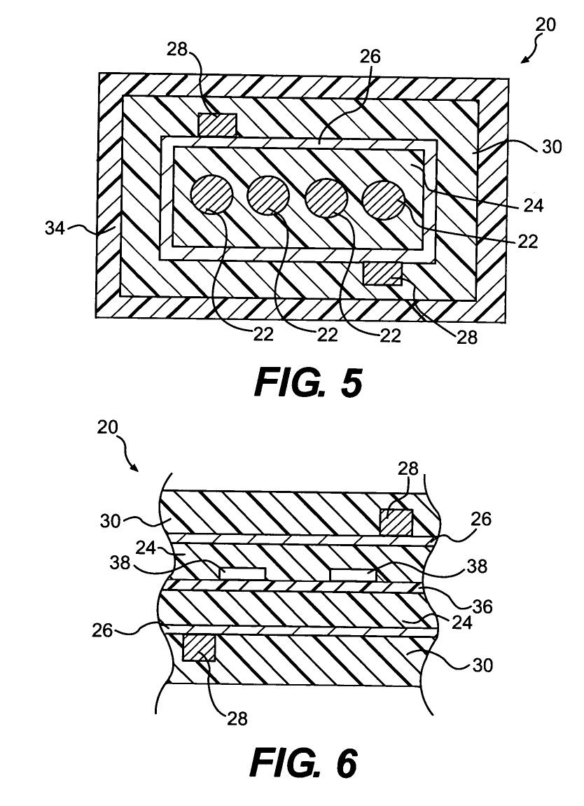

In another embodiment, shown in FIG. 5, the interconnect 20 of the present invention is configured as an electrical connector. In this embodiment, the interconnect 20 further comprises an insulated cover 34 disposed on the second lossy dielectric layer 30. The cover 34 may comprise polymers, resins, composites, and/or other materials.

In another embodiment, shown in FIG. 6, the interconnect 20 of the present invention is configured as at least a portion of a circuit board. In this embodiment, the interconnect 20 further comprises a substrate 36 supporting the plurality of first conductive elements (not shown), which comprise leads for at least one integrated circuit 38. The circuit board may comprise a standard rigid circuit board or a flex circuit. Flex circuit applications may include inkjet printers and other applications.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

What is claimed is:

1. A charge-dissipative electrical interconnect, comprising:
at least one first conductive element;
a first lossy dielectric layer surrounding the at least one first conductive element;
a first shielding element surrounding the first lossy dielectric layer;
at least one grounding conductive element electrically contacting the first shielding element; and
a second lossy dielectric layer surrounding the first shielding element.

2. The charge-dissipative electrical interconnect of claim 1, wherein the at least one grounding conductive element is disposed between the first lossy dielectric layer and the first shielding element.

3. The charge-dissipative electrical interconnect of claim 1, wherein the first shielding element is disposed between the first lossy dielectric layer and the at least one grounding conductive element.

4. The charge-dissipative electrical interconnect of claim 1, wherein the at least one grounding conductive element is in electrical contact with one of the first lossy dielectric layer and the second lossy dielectric layer.

5. The charge-dissipative electrical interconnect of claim 1, wherein the at least one first conductive element is configured to transmit an electrical signal.

6. The charge-dissipative electrical interconnect of claim 1, wherein the at least one grounding conductive element is configured to transfer charge from at least one of the first lossy dielectric layer, the second lossy dielectric layer, and the shielding element, to a reference element.

7. The charge-dissipative electrical interconnect of claim 1, wherein the first shielding element comprises at least one of a metal foil and a metal wire braid.

8. The charge-dissipative electrical interconnect of claim 7, wherein the first shielding element comprises silver-plated copper.

9. The charge-dissipative electrical interconnect of claim 1, wherein the lossy dielectric comprises a thermoplastic polyester elastomer.

10. The charge-dissipative electrical interconnect of claim 9, wherein the thermoplastic polyester elastomer comprises a crystalline hard segment and an amorphous soft segment.

11. The charge-dissipative electrical interconnect of claim 10, wherein the thermoplastic polyester elastomer comprises butylene/poly(alkylene ether)phthalate.

12. The charge-dissipative electrical interconnect of claim 1, wherein the lossy dielectric has a resistivity ranging from approximately 1×10⁸ Ω-m to approximately 1×10¹¹ Ω-m.

13. The charge-dissipative electrical interconnect of claim 12, wherein the lossy dielectric has a resistivity of approximately 1×10⁹ Ω-m.

14. The charge-dissipative electrical interconnect of claim 1, wherein the at least one grounding conductive element has a lower impedance than the at least one first conductive element relative to a reference element.

15. The charge-dissipative electrical interconnect of claim 14, wherein the at least one grounding conductive element has an impedance of less than about 10 Ω and the at least one first conductive element has an impedance of greater than about 50 Ω relative to the reference element.

16. The charge-dissipative electrical interconnect of claim 15, wherein the at least one grounding conductive element has an impedance of approximately 1 Ω and the at least one first conductive element has an impedance of approximately 75 Ω relative to the reference element.

17. The charge-dissipative electrical interconnect of claim 1, wherein the at least one first conductive element comprises a plurality of first conductive elements.

18. The charge-dissipative electrical interconnect of claim 17, wherein each first conductive element is surrounded by a discrete first lossy dielectric layer.

19. The charge-dissipative electrical interconnect of claim 18, wherein the charge-dissipative electrical interconnect comprises a cable.

20. The charge-dissipative electrical interconnect of claim 18, wherein each first lossy dielectric layer is in electrical contact with at least one of a grounding conductive element and a first lossy dielectric layer that is in electrical contact with a grounding conductive element.

21. The charge-dissipative electrical interconnect of claim 18, further comprising a second shielding element substantially within the first shielding element.

22. The charge-dissipative electrical interconnect of claim 21, wherein the second shielding element surrounds at least one first conductive element and at least one grounding conductive element.

23. The charge-dissipative electrical interconnect of claim 17, wherein the first conductive elements are surrounded by a common first lossy dielectric layer.

24. The charge-dissipative electrical interconnect of claim 23, wherein the common first lossy dielectric layer comprises a substantially continuous coating on the first conductive elements.

25. The charge-dissipative electrical interconnect of claim 23, wherein the charge-dissipative electrical interconnect comprises a ribbon cable.

26. The charge-dissipative electrical interconnect of claim 23, further comprising an insulated cover disposed on the second lossy dielectric layer.

27. The charge-dissipative electrical interconnect of claim 26, wherein the charge-dissipative electrical interconnect comprises an electrical connector.

28. The charge-dissipative electrical interconnect of claim 23, further comprising a substrate supporting the plurality of first conductive elements.

29. The charge-dissipative electrical interconnect of claim 28, wherein the plurality of first conductive elements comprise leads for at least one integrated circuit.

30. The charge-dissipative electrical interconnect of claim 29, wherein the charge-dissipative electrical interconnect comprises at least a portion of a circuit board.

31. The charge-dissipative electrical interconnect of claim 17, wherein the at least one grounding conductive element comprises a plurality of grounding conductive elements.

32. A charge-dissipative electrical interconnect, comprising:
a plurality of first conductive elements;
a first lossy dielectric layer surrounding the first conductive elements;
a first shielding element surrounding the first lossy dielectric layer;
a second lossy dielectric layer surrounding the first shielding element; and
at least one grounding conductive element in electrical contact with the first shielding element and at least one of the first lossy dielectric layer and the second lossy dielectric layer.

33. The charge-dissipative electrical interconnect of claim 32, wherein each first conductive element is surrounded by a discrete first lossy dielectric layer.

34. The charge-dissipative electrical interconnect of claim 33, wherein the first conductive elements and the at least one grounding conductive element are arranged in a cable to form a substantially circular array in cross-section.

35. The charge-dissipative electrical interconnect of claim 34, further comprising a second shielding element within the first shielding element.

36. The charge-dissipative electrical interconnect of claim 35, wherein the second shielding element surrounds at least one first conductive element and at least one grounding conductive element.

37. The charge-dissipative electrical interconnect of claim 32, wherein the at least one grounding conductive element comprises a plurality of grounding conductive elements.

38. The charge-dissipative electrical interconnect of claim 32, wherein the at least one grounding conductive element is configured to transfer charge from at least one of the first lossy dielectric layer, the second lossy dielectric layer, and the shielding element, to a reference element.

39. The charge-dissipative electrical interconnect of claim 32, wherein the first shielding element comprises at least one of a metal foil and a metal wire braid.

40. The charge-dissipative electrical interconnect of claim 32, wherein the lossy dielectric comprises a thermoplastic polyester elastomer.

41. The charge-dissipative electrical interconnect of claim 40, wherein the thermoplastic polyester elastomer comprises a crystalline hard segment and an amorphous soft segment.

42. The charge-dissipative electrical interconnect of claim 40, wherein the thermoplastic polyester elastomer comprises butylene/poly(alkylene ether) phthalate.

43. The charge-dissipative electrical interconnect of claim 32, wherein the lossy dielectric has a resistivity of approximately 1×10⁹ Ω-m.

44. The charge-dissipative electrical interconnect of claim 32, wherein the first conductive elements are surrounded by a common first lossy dielectric layer.

45. The charge-dissipative electrical interconnect of claim 44, wherein the common first lossy dielectric layer comprises a substantially continuous coating on the first conductive elements.

46. The charge-dissipative electrical interconnect of claim 44, wherein the charge-dissipative electrical interconnect comprises a ribbon cable.

47. The charge-dissipative electrical interconnect of claim 44, further comprising an insulated cover disposed on the second lossy dielectric layer.

48. The charge-dissipative electrical interconnect of claim 47, wherein the charge-dissipative electrical interconnect comprises an electrical connector.

49. The charge-dissipative electrical interconnect of claim 44, further comprising a substrate supporting the plurality of first conductive elements.

50. The charge-dissipative electrical interconnect of claim 49, wherein the plurality of first conductive elements comprise leads for at least one integrated circuit.

51. The charge-dissipative electrical interconnect of claim 50, wherein the charge-dissipative electrical interconnect comprises at least a portion of a circuit board.

52. The charge-dissipative electrical interconnect of claim 32, wherein the at least one grounding conductive element is in electrical contact with the first shielding element along substantially the entire interconnect.

53. The charge-dissipative electrical interconnect of claim 32, wherein the at least one grounding conductive element is in electrical contact with the first shielding element only at end portions of the interconnect.

54. The charge-dissipative electrical interconnect of claim 1, wherein the at least one grounding conductive element electrically contacts the first shielding element along substantially the entire interconnect.

55. The charge-dissipative electrical interconnect of claim 1, wherein the at least one grounding conductive element electrically contacts the first shielding element only at end portions of the interconnect.
